(19) United States
(12) Patent Application Publication
(10) Pub. No.: US 2011/0234764 A1
(43) Pub. Date: Sep. 29, 2011

(54) IMAGING DEVICE

(75) Inventors: TORU ICHIMURA, Osaka (JP); NOBUTAKA KANAYAMA, Osaka (JP); NARITOSHI KAGAYA, Osaka (JP); JUNYA YAMADA, Osaka (JP); YOSHITOMO KATO, Osaka (JP)

(73) Assignee: PANASONIC CORPORATION, Osaka (JP)

(21) Appl. No.: 13/038,690

(22) Filed: Mar. 2, 2011

(30) Foreign Application Priority Data
Mar. 26, 2010 (JP) 2010-071966

(51) Int. Cl. H04N 13/02

(52) U.S. Cl. 348/47; 348/E13.074

(57) ABSTRACT

The imaging device includes a first optical system, a second optical system, a first support frame, a second support frame, a frame member, and a support member. The first support frame has a first contact portion and supports the first optical system. The second support frame supports the second optical system. The first and second support frames on the frame member are mounted, and this frame member comes into contact with the first contact portion at three or more points. The support member couples the first support frame to the frame member in a state in which the first receiver comes into contact with the first contact portion. The points of contact between the first contact portion and the first receiver are disposed on an imaginary spherical plane.

### CROSS-REFERENCE TO RELATED APPLICATIONS

This application claims priority under 35 U.S.C. §119 to Japanese Patent Application No. 2010-071966, filed on Mar. 26, 2010. The entire disclosure of Japanese Patent Application No. 2010-071966 is hereby incorporated herein by reference.

### BACKGROUND

1. Technical Field

The technology disclosed herein relates to a two-lens imaging device capable of capturing three-dimensional video.

2. Background Information

A three-dimensional camera was known in the past in which right-eye and left-eye images were captured by disposing two cameras side by side. The two lens devices used in this three-dimensional camera were designed so that focus, zoom (focal distance), aperture, and other such control parameters were driven simultaneously so that the optical conditions would always coincide.

However, even when lens devices having the same specifications were used for this three-dimensional camera, manufacturing error or machining error made it difficult to set the optical conditions of both lens devices the same.

In view of this, it has been proposed that the state of control parameters be corrected on the basis of correction data so that the focus and zoom of the two lens devices would coincide (see Japanese Patent Publication No. 3,117,303, for example).

If the optical center of the two lens devices should become offset, however, the subjects that appear in the optical center will be different, so the video image will not look right.

In view of this, a technique has been proposed in which the optical center of two lens devices is adjusted (see Japanese Laid-Open Patent Application 2007-52060, for example).

However, to capture a suitable three-dimensional video image, the relative positions and angles of the two lens devices must be adjusted to the proper positions and angles, but with the technique discussed in JP2007-52060, all that is done is to adjust the offset in the optical center of the two lens devices by changing the positions of the lenses.

Also, the structure used to adjust the relative positions and angles of the two cameras tends to make the overall device bulkier.

### SUMMARY

An imaging device disclosed herein includes a first optical system, a second optical system, a first support frame, a second support frame, a frame member, and a support member. The first support frame has a first contact portion and supports the first optical system. The second support frame supports the second optical system. The first and second support frames on the frame member are mounted, and this frame member comes into contact with the first contact portion at three or more points. The support member couples the first support frame to the frame member in a state in which the first receiver comes into contact with the first contact portion. The points of contact between the first contact portion and the first receiver are disposed on an imaginary spherical plane.

### BRIEF DESCRIPTION OF DRAWINGS

Referring now to the attached drawings which form a part of this original disclosure:

FIG. 1 is an oblique view of the overall configuration of an imaging device (first embodiment);

FIG. 2 is an oblique view of the layout of right-eye and left-eye imaging units (first embodiment);

FIG. 3 is an oblique view of the right-eye imaging unit;

FIG. 4 is a bottom view of the right-eye imaging unit;

FIG. 5 is a cross section of the right-eye imaging unit;

FIG. 6 is an oblique view of the overall configuration of a frame member;

FIG. 7 is a plan view of the frame member;

FIG. 8 is a cross section of the right-eye imaging unit and the frame member;

FIG. 9 is a detail enlargement of FIG. 8;

FIG. 10 is a plan view of the right-eye imaging unit, the left-eye imaging unit, and the frame member;

FIG. 11 is a plan view of the right-eye imaging unit, the left-eye imaging unit, and a convergence angle adjustment knob (second embodiment);

FIG. 12 is a cross section of the right-eye imaging unit (second embodiment); and

FIG. 13 is a cross section of the convergence angle adjustment knob (second embodiment).

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

1. Overall Configuration of Imaging Device 1

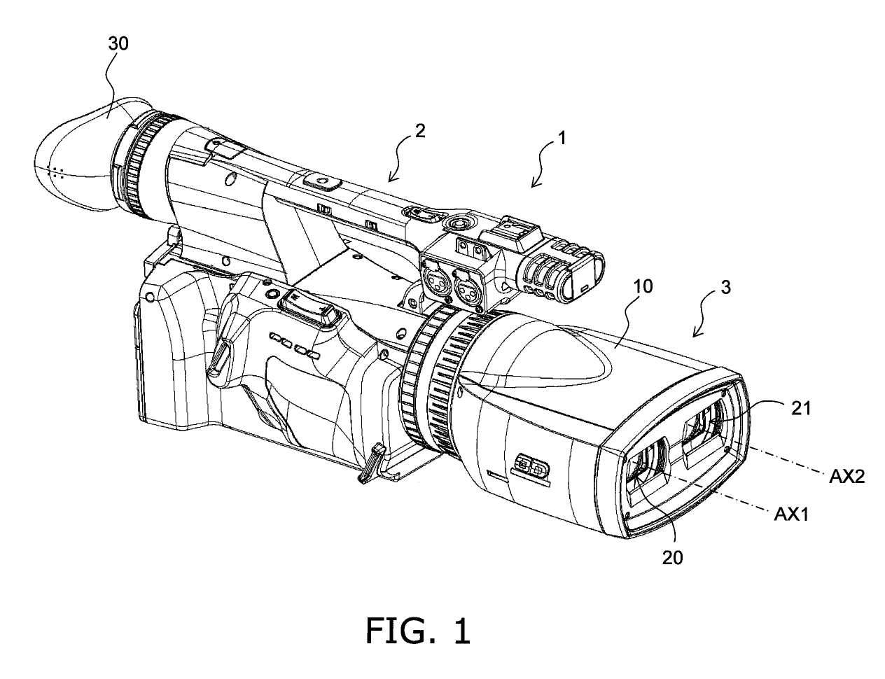

As shown in FIG. 1, an imaging device 1 includes a lens unit 3 and a body 2. The lens unit 3 captures right-eye and left-eye video by using a right-eye optical system 20 and a left-eye optical system 21 disposed inside a housing 10. Three-dimensional video can be captured by capturing right-eye and left-eye video images. The right-eye and left-eye video images are shown on a viewfinder 30 provided to the body 2. The user can perform imaging while checking on the subject through the viewfinder 30. The captured three-dimensional video is recorded to a semiconductor memory card, an optical disk, a magnetic tape, or any of various other recording media (not shown) disposed inside the body 2.

In the description that follows, using the imaging device 1 as a reference, the subject side will be called the front direction, the opposite direction will be called the rear direction, the right side facing the front direction will be called the right direction, and the left side facing the front direction will be called the left direction. The orientation of the imaging device 1 during its use is not limited to these directions.

2. Configuration of Lens Unit 3

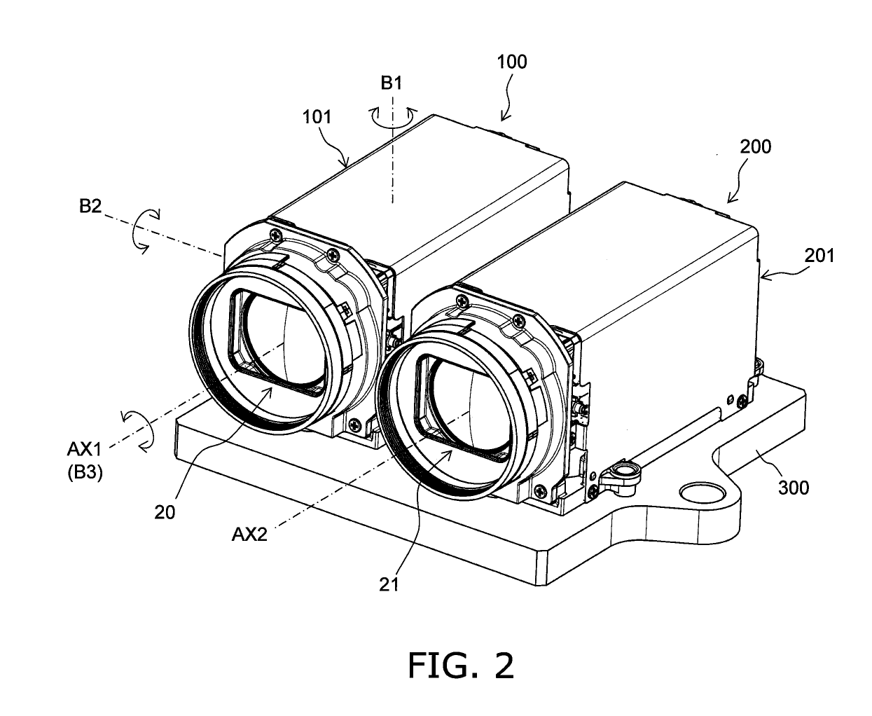

As shown in FIGS. 1 and 2, the lens unit 3 has a housing 10, a base plate 300, a right-eye imaging unit 100, and a left-eye imaging unit 200.

(1) Housing 10

As shown in FIG. 1, the housing 10 constitutes the outer shell of the lens unit 3, and is mounted to the body 2. The right-eye imaging unit 100, the left-eye imaging unit 200, and the base plate 300 are disposed inside the housing 10.

(2) Base Plate 300

The base plate 300 (an example of a frame member) is fixed to the housing 10. As shown in FIG. 2, the right-eye imaging unit 100 and the left-eye imaging unit 200 are mounted to the base plate 300.

(3) Right-Eye Imaging Unit 100

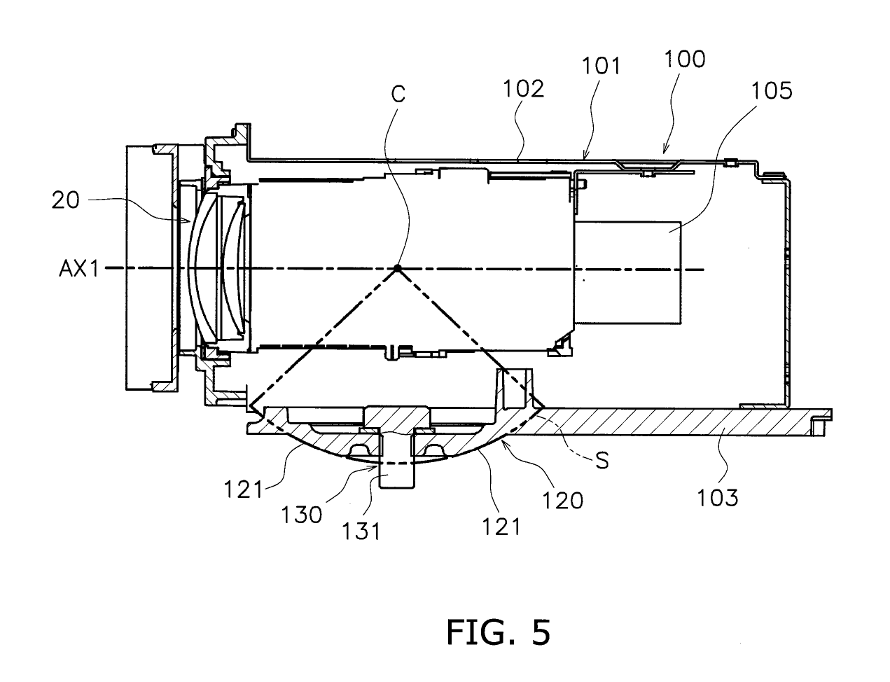

The right-eye imaging unit 100 is provided in order to capture right-eye video. As shown in FIG. 5, the right-eye imaging unit 100 has the right-eye optical system 20 (an example of a first or second optical system), a right-eye lens barrel 101 (an example of a first or second support frame), and an imaging element unit 105. The right-eye optical system 20 and the imaging element unit 105 are fixed to the right-eye lens barrel 101. The right-eye lens barrel 101 supports the right-eye optical system 20 and the imaging element unit 105, and is mounted to the base plate 300.

The right-eye optical system 20 includes, for example, an objective lens, a zoom lens, an aperture, an OIS unit, and a focus lens (not shown). The right-eye optical system 20 collects light from a subject and forms an optical image of the subject. The right-eye optical system 20 has an optical axis AX1.

The imaging element unit 105 converts an optical image formed by the right-eye optical system 20 into an electrical signal. The imaging element 105 has, for example, a Complementary Metal Oxide Semiconductor (CMOS) imaging sensor or a Charge Coupled Device (CCD) imaging sensor.

(4) Left-Eye Imaging Unit 200

The left-eye imaging unit 200 is provided in order to capture left-eye video. The left-eye imaging unit 200 has the left-eye optical system 21 (an example of a first or second optical system), a left-eye lens barrel 201 (an example of a first or second support frame), and an imaging element unit (not shown). The left-eye optical system 21 and the imaging element unit are fixed to the left-eye lens barrel 201. The left-eye lens barrel 201 supports the left-eye optical system 21 and the imaging element unit, and is mounted to the base plate 300.

The left-eye optical system 21 has the same configuration as the right-eye optical system 20. More specifically, the left-eye optical system 21 includes, for example, an objective lens, a zoom lens, an aperture, an OIS unit, and a focus lens (not shown). The left-eye optical system 21 collects light from a subject and forms an optical image of the subject. The left-eye optical system 21 has an optical axis AX2. The angle formed by the optical axis AX1 and the optical axis AX2 is called the convergence angle.

The imaging element unit has the same configuration as the imaging element unit 105. The imaging element unit converts the optical image formed by the left-eye optical system 21 into an electrical signal, and produces image data about the subject. The imaging element unit has, for example, a Complementary Metal Oxide Semiconductor (CMOS) imaging sensor or a Charge Coupled Device (CCD) imaging sensor.

3. Support Structure of Right-Eye Imaging Unit 100 and Left-Eye Imaging Unit 200

In order to perform the proper three-dimensional imaging with the imaging device 1, the positional relation between the right-eye imaging unit 100 and the left-eye imaging unit 200 must be properly adjusted. Examples of adjustments that are necessary include the up and down orientation of the right-eye imaging unit 100 and the left-eye imaging unit 200, the left and right orientation of the right-eye imaging unit 100 and the left-eye imaging unit 200 (that is, the convergence angle), and the angle of the right-eye imaging unit 100 and the left-eye imaging unit 200 around the optical axis (see FIG. 2, for example).

If the right-eye imaging unit 100 and the left-eye imaging unit 200 are not in the proper up and down orientation, there will be greater offset in the right-eye and left-eye video images in the up and down direction, and either the three-dimensional image will not be as good, or a three-dimensional cannot be obtained at all.

It is also necessary to set the proper convergence angle in order to obtain a good three-dimensional image.

If the angle of the right-eye imaging unit 100 and the left-eye imaging unit 200 around the optical axis is not right, the right-eye and left-eye video images will end up being rotationally offset, and either the three-dimensional image will not be as good, or a three-dimensional cannot be obtained at all.

In view of this, in order to perform these adjustments, with the imaging device 1 the left-eye imaging unit 200 is fixed to the base plate 300, while the angle of the right-eye imaging unit 100 can be adjusted with respect to the base plate 300 and the left-eye imaging unit 200.

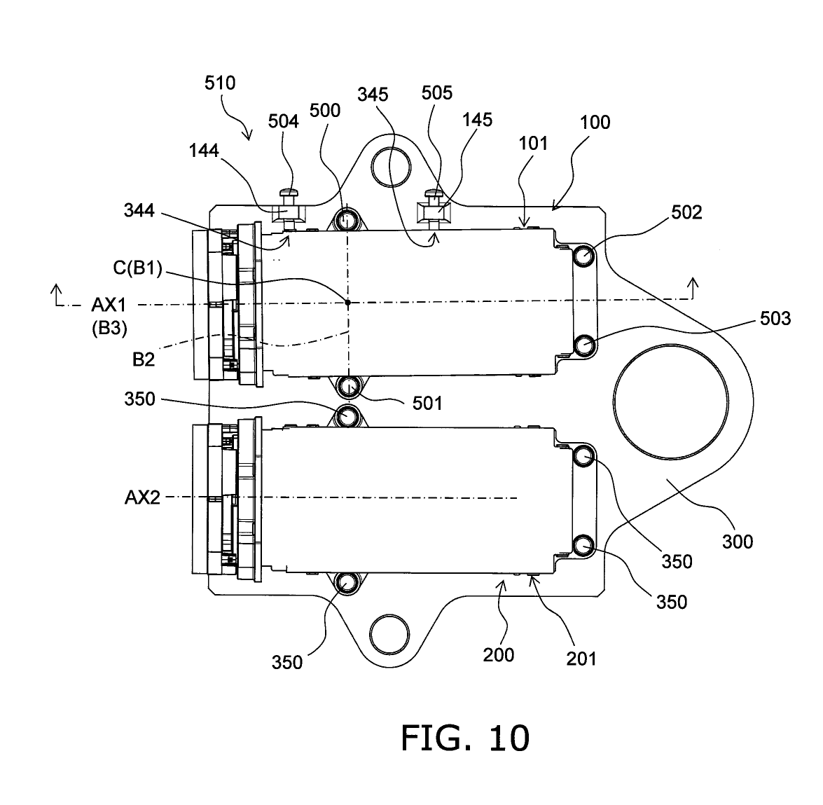

More specifically, as shown in FIG. 10, the left-eye imaging unit 200 is fixed to the base plate 300 by four fixing screws 350.

Meanwhile, the right-eye imaging unit 100 is mounted to the base plate 300 by four adjusting screws 500, 501, 502, and 503, and these adjusting screws 500 to 503 can be turned to adjust the angle of the right-eye imaging unit 100 around the optical axis with respect to the base plate 300. Also, the adjusting screws 500 to 503 can be turned to adjust the orientation of the right-eye imaging unit 100 with respect to the base plate 300 in the up and down direction. Furthermore, adjusting screws 504 and 505 can be turned to adjust the convergence angle.

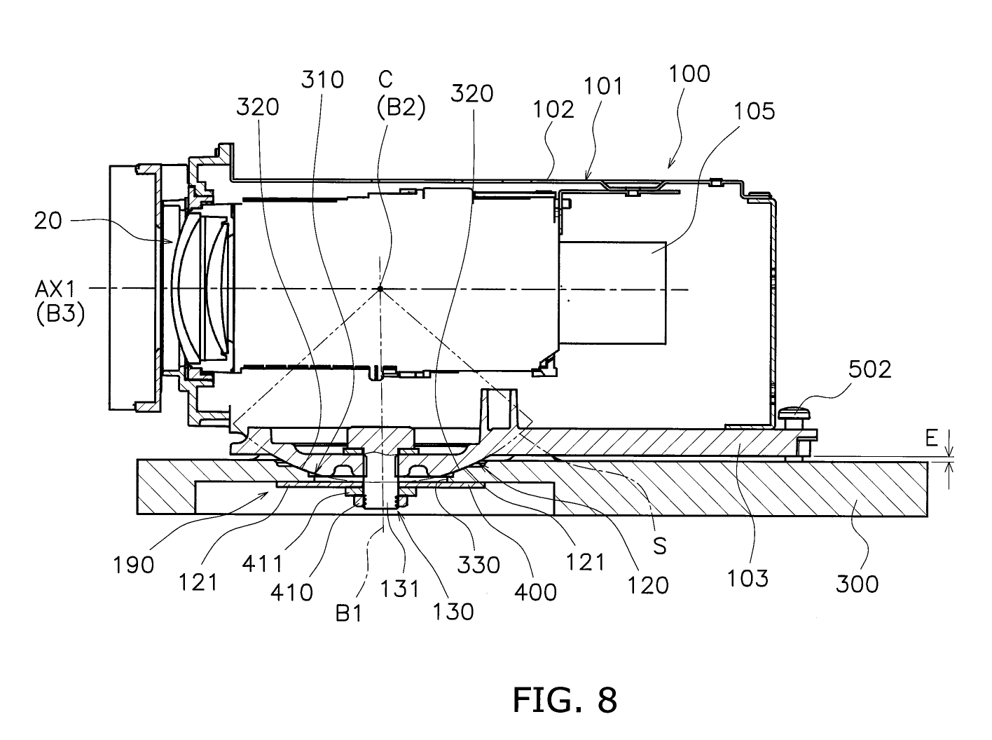

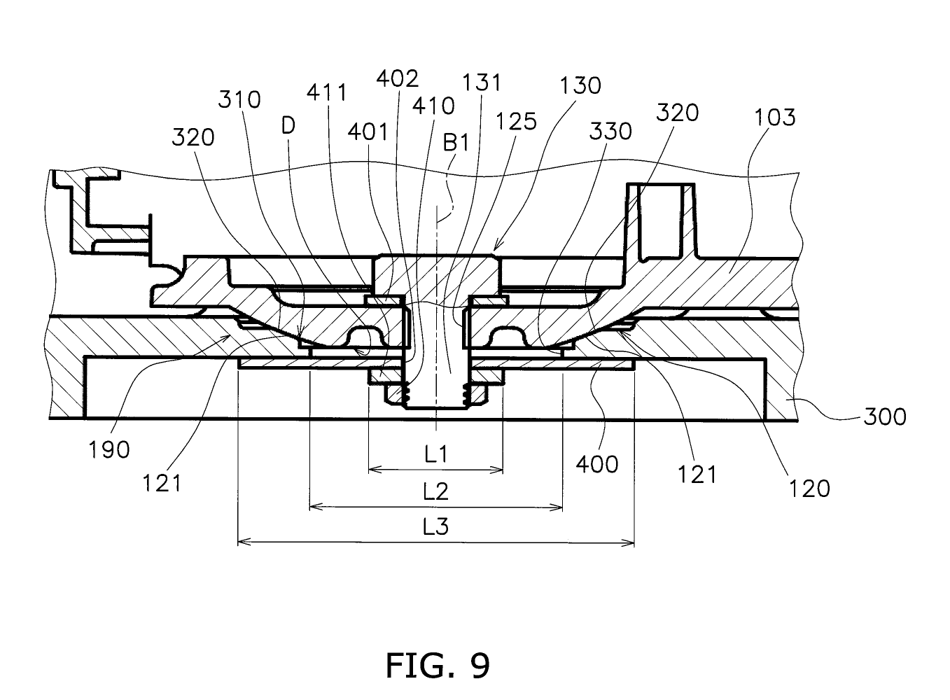

In addition, a spherical plane support mechanism 190 is employed for the mounting component of the right-eye imaging unit 100 and the base plate 300. More specifically, as shown in FIGS. 8 and 9, the spherical plane support mechanism 190 has a contact portion 120, a receiver 310, a bolt 130, a washer 401, an elastic plate 400, a washer 411, and a nut 410. The bolt 130, the washer 401, the elastic plate 400, the washer 411, and the nut 410 couple the right-eye lens barrel 101 to the base plate 300 in a state in which the receiver 310 is in contact with the contact portion 120.

As shown in FIGS. 8 and 9, the contact portion 120 (an example of a first or second contact portion) is provided to the right-eye lens barrel 101. More specifically, the right-eye lens barrel 101 has a lens barrel cover 102, a bottom plate 103, and the bolt 130. The right-eye optical system 20 and the imaging element unit 105 are fixed to the lens barrel cover 102. The lens barrel cover 102 is fixed on the bottom plate 103.

The bottom plate 103 has the contact portion 120 fitted into the receiver 310. The contact portion 120 is a portion that protrudes substantially in the form of a spherical plane, and comes into contact with the receiver 310. The contact portion 120 has an annular contact face 121 (an example of a contact face). The contact face 121 is formed along an imaginary spherical plane S (an example of an imaginary spherical plane), and comes into contact with a receiving face 320 (discussed below) of the receiver 310. The center C of the imaginary spherical plane S is disposed within the right-eye lens barrel 101. More precisely, the center C of the imaginary spherical plane S is disposed on the optical axis AX1 (an example of an optical axis) of the right-eye optical system 20. Therefore, even if the orientation of the right-eye imaging unit 100 is changed in the up and down direction or in the left and right direction along the shape of the contact portion 120, the position of the center C of the imaginary spherical plane S with respect to the base plate 300 always remains the same.

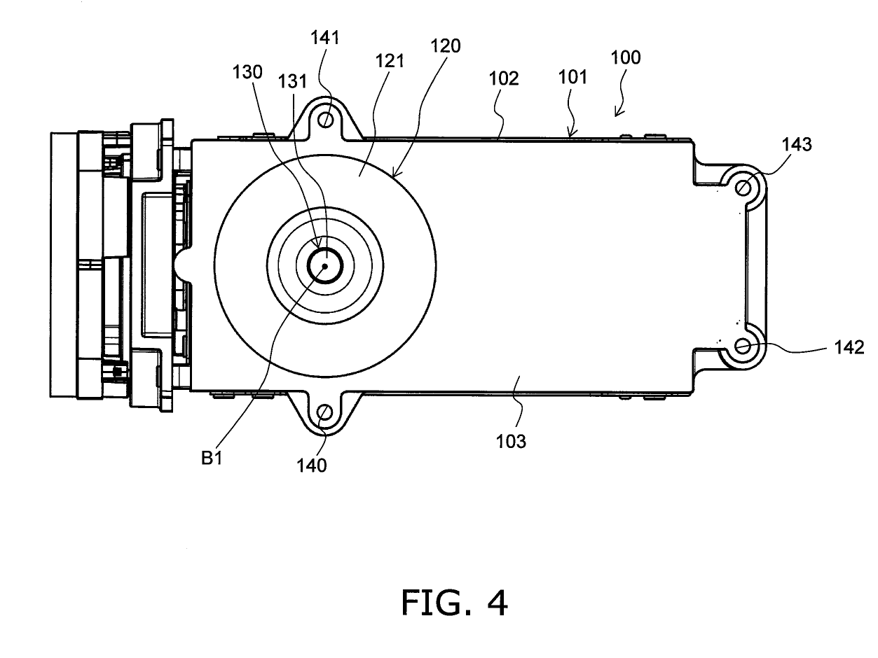

Also, as shown in FIG. 9, the contact portion 120 has a threaded hole 125. The bolt 130 is threaded into the threaded hole 125. The contact portion 120 is circular when viewed from below, and the bolt 130 is located in the center of the threaded hole 125 (see FIG. 4). The threads 131 of the bolt 130 are threaded into the threaded hole 125, and protrude from the contact portion 120. The washer 411 is sandwiched between the bolt 130 and the contact portion 120. Thus, the bolt 130 is integrally mounted to the bottom plate 103, so when the angle of the right-eye lens barrel 101 with respect to the base plate 300 changes along the imaginary spherical plane S, the angle of the bolt 130 with respect to the base plate 300 also changes. In this embodiment, the center line of the bolt 130 passes through the center C of the imaginary spherical plane S. Accordingly, in adjusting the convergence angle, the right-eye imaging unit 100 rotates around a rotational axis B1, which corresponds to the center line of the bolt 130.

The receiver 310 (an example of a first or second receiver) is provided to the base plate 300. More specifically, as shown in FIGS. 8 and 9, the receiver 310 is recessed to conform to the shape of the contact portion 120. The contact portion 120 is fitted into the receiver 310. The receiver 310 has the annular receiving face 320 (an example of a receiving face) and an opening 330 (an example of an opening). The receiving face 320 has a shape that is substantially complementary with the contact face 121, and is formed along the imaginary spherical plane S just as is the contact face 121. The receiving face 320 comes into contact with the contact face 121 at three or more points, and the points of contact between the contact portion 120 and the receiver 310 are disposed on the imaginary spherical plane S. In a state in which the contact portion 120 is fitted into the receiver 310, a gap E is ensured between the bottom plate 103 and the base plate 300 (see FIG. 10). This gap E is provided so that the bottom plate 103 will not touch the base plate 300 in adjusting the angle of the right-eye lens barrel 101.

As shown in FIGS. 8 and 9, the opening 330 is disposed on the inside of the receiving face 320. The threads 131 of the bolt 130 are inserted into the opening 330. The diameter L2 of the opening 330 is greater than the diameter of the threads 131, so the threads 131 do not interfere with the edge of the opening 330 even if the angle of the right-eye imaging unit 100 changes with respect to the base plate 300. The nut 410 (an example of a support member, and an example of a fixing member) is mounted to the end of the threads 131 (an example of a protrusion). The washer 411 (an example of a support member, and an example of a fixing member) and the elastic plate 400 are sandwiched between the base plate 300 and the nut 410 (more precisely, between the receiver 310 and the nut 410) so that the angle of the right-eye imaging unit 100 with respect to the base plate 300 can be adjusted.

The elastic plate 400 (an example of a support member, and an example of an elastic member) is an annular, flat member, and is disposed so as to be capable of elastic deformation according to changes in the angle of the right-eye lens barrel 101 with respect to the base plate 300. The elastic plate 400 is formed by a relatively thin leaf spring, for example, and has a hole 402. The threads 131 of the bolt 130 are inserted into the hole 402. The contact portion 120 and the elastic plate 400 are tightened together by the nut 410 and the bolt 130. As shown in FIG. 9, a gap D is ensured between the contact portion 120 and the elastic plate 400, so a space in which the elastic plate 400 can elastically deform is formed between the contact portion 120 and the elastic plate 400.

The maximum major diameter L3 of the elastic plate 400 (an example of the maximum major diameter of an elastic member) is greater than the minimum minor diameter L2 of the opening 330 (an example of the minimum minor diameter of an opening). Meanwhile, the major diameter L1 of the washer 411 (an example of the maximum major diameter of a fixing member) is less than the minimum minor diameter L2 of the opening 330. Accordingly, even if the angle of the right-eye imaging unit 100 with respect to the base plate 300 should change, causing the nut 410 to tilt with respect to the base plate 300, the elastic plate 400 will elastically deform, which maintains the coupled state provided by the nut 410 and the bolt 130, while absorbing the tilting of the nut 410 and the washer 411. Therefore, the angle of the right-eye imaging unit 100 with respect to the base plate 300 can be adjusted in a state in which the right-eye imaging unit 100 is coupled to the base plate 300.

4. Angle Adjustment Mechanism of Right-Eye Imaging Unit 100

We will now describe the mechanism for adjusting the up and down orientation, the left and right orientation (that is, the convergence angle), and the twisting in the rotational direction around the optical axis AX1 of the right-eye imaging unit 100 with respect to the left-eye imaging unit 200 in a state in which the right-eye imaging unit 100 is adjustably held on the base plate 300.

As shown in FIG. 10, the lens unit 3 further has an adjustment mechanism 510 for adjusting the angle of the right-eye lens barrel 101 with respect to the base plate 300.

The adjustment mechanism 510 is provided in order to perform the three types of adjustment mentioned above. More precisely, the adjustment mechanism 510 is provided in order to adjust the angle of the right-eye lens barrel 101 with respect to the base plate 300 around the rotational axis B1. The rotational axis B1 (an example of a first, second, or third rotational axis) passes through the center C of the imaginary spherical plane S. The adjustment mechanism 510 has two adjusting screws 504 and 505 (an example of a first, second, or third adjustment member). The adjusting screws 504 and 505 are provided so that rotational force can be imparted to the right-eye lens barrel 101 around the rotational axis B1.

More precisely, two supports 144 and 145 are formed on the base plate 300. The adjusting screw 504 is threaded into a threaded hole 144a of the support 144 toward the right-eye imaging unit 100. The adjusting screw 505 is threaded into a threaded hole 145a of the support 145 toward the right-eye imaging unit 100. The distal end of the adjusting screw 504 touches a screw receiver 344 provided to the side face of the right-eye lens barrel 101, and the distal end of the adjusting screw 505 touches a screw receiver 345 of the right-eye lens barrel 101.

When viewed from above the right-eye imaging unit 100, clockwise rotational force is exerted on the right-eye lens barrel 101 when the adjusting screw 504 is threaded in. On the other hand, when viewed from above the right-eye imaging unit 100, counter-clockwise rotational force is exerted on the right-eye lens barrel 101 when the adjusting screw 505 is threaded in.

Thus, when the adjusting screws 504 and 505 are turned, that generates a force that pushes on the side wall of the right-eye lens barrel 101, allowing the angle of the right-eye imaging unit 100 around the rotational axis B1 to be adjusted. After adjustment, the angle of the right-eye imaging unit 100 around the rotational axis B1 can be maintained by the adjusting screws 504 and 505.

The adjustment mechanism 510 is provided in order to adjust the angle of the right-eye lens barrel 101 with respect to the base plate 300 around a rotational axis B2, and is also provided in order to adjust the angle of the right-eye lens barrel 101 with respect to the base plate 300 around a rotational axis B3. The rotational axis B2 (an example of a first, second, or third rotational axis) is perpendicular to the rotational axis B1, and passes through the center C of the imaginary spherical plane S. In this embodiment, the rotational axis B2 extends in the left and right direction. The rotational axis B3 (an example of a first, second, or third rotational axis) is perpendicular to the rotational axis B1 and the rotational axis B2. In this embodiment, the rotational axis B3 extends in the forward and backward direction, and coincides with the optical axis AX1.

The adjustment mechanism 510 further has the four adjusting screws 500, 501, 502, and 503 (examples of a first, second, or third adjustment member). These are provided so that rotational force can be imparted to the right-eye lens barrel 101. Furthermore, the adjusting screws 500, 501, 502, and 503 are provided so that rotational force can be imparted to the right-eye lens barrel 101 around the rotational axis B3.

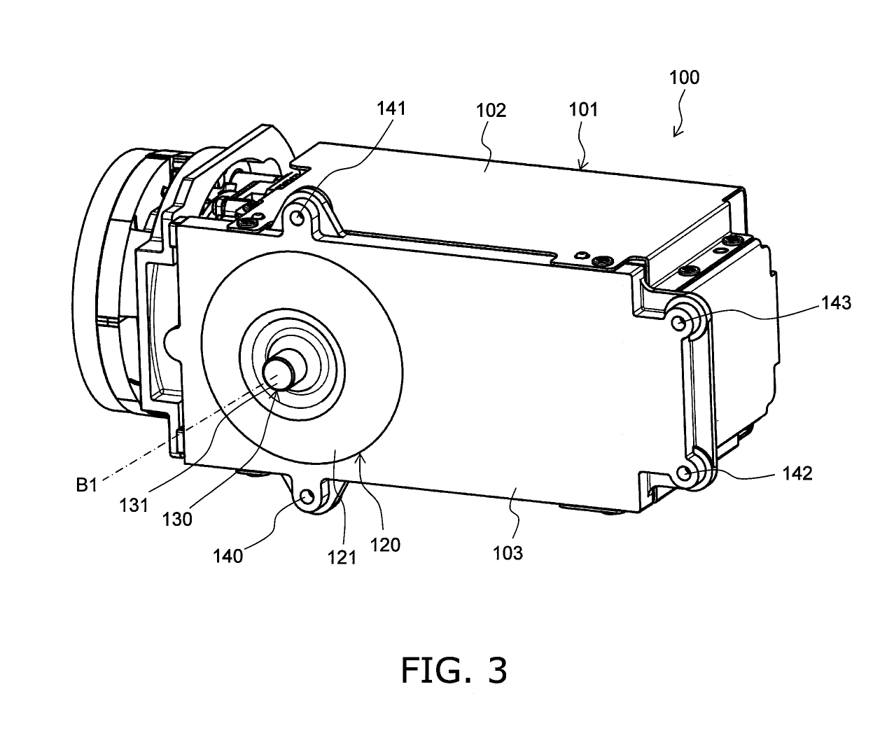

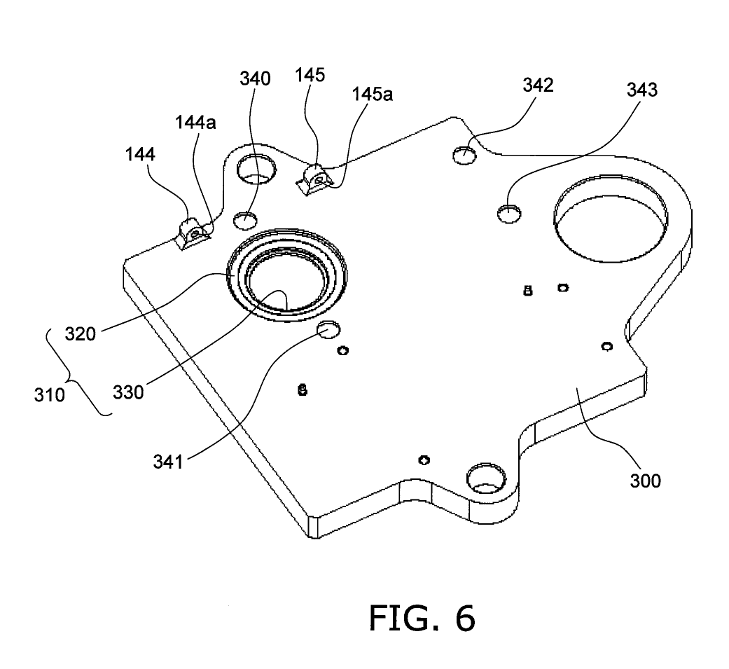

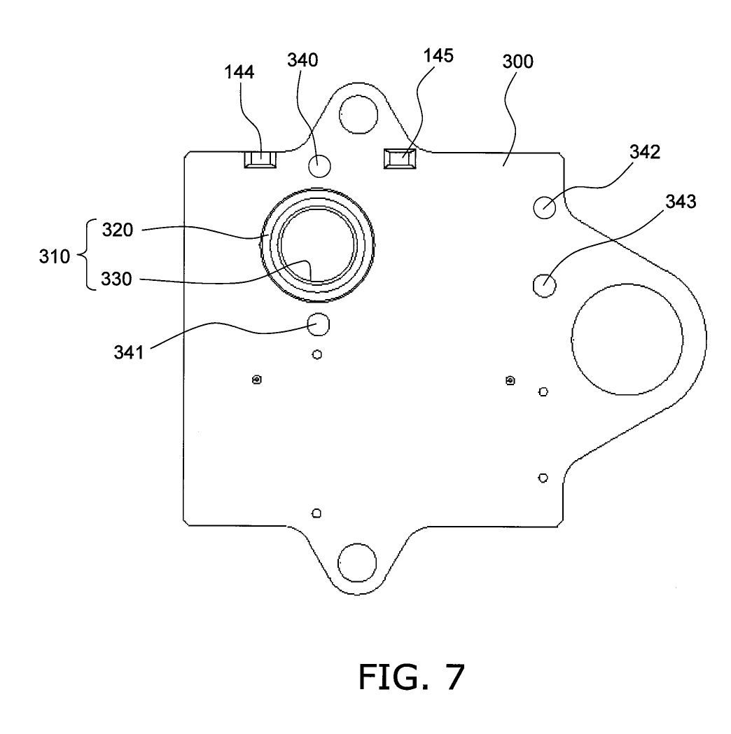

The adjusting screws 500 and 501 are threaded into screw holes 140 and 141 in the right-eye lens barrel 101 (see FIGS. 3 and 4). The adjusting screws 500 and 501 are disposed on the left and right of the right-eye lens barrel 101, respectively. Screw receivers 340 and 341 are formed in the base plate 300 (see FIGS. 6 and 7). The distal ends of the adjusting screws 500 and 501 are touching the screw receivers 340 and 341, respectively.

The adjusting screws 502 and 503 are threaded into screw holes 142 and 143 of the right-eye lens barrel 101 (see FIGS. 3 and 4). In this embodiment, the adjusting screws 502 and 503 are disposed on the opposite side from the subject with respect to the rotational axis B2, and are disposed at the rear of the right-eye imaging unit 100. Screw receivers 342 and 343 are formed in the base plate 300 (see FIGS. 6 and 7). The distal ends of the adjusting screws 502 and 503 are touching the screw receivers 342 and 343, respectively.

When the adjusting screws 500 and 502 are threaded in, the right side part of the right-eye lens barrel 101 tries to move away from the base plate 300. When the right-eye imaging unit 100 is viewed from the subject side, rotational force that is clockwise around the rotational axis B3 is exerted on the right-eye lens barrel 101 at this point. Meanwhile, when the adjusting screws 501 and 503 are threaded in, the left side part of the right-eye lens barrel 101 tries to move away from the base plate 300. When the right-eye imaging unit 100 is viewed from the subject side, rotational force that is counter-clockwise around the rotational axis B3 is exerted on the right-eye lens barrel 101 at this point.

Also, when the adjusting screws 502 and 503 are threaded in, the rear part of the right-eye lens barrel 101 tries to move away from the base plate 300. When the right-eye imaging unit 100 is viewed from the left-eye imaging unit 200 side, rotational force that is clockwise around the rotational axis B2 is exerted on the right-eye lens barrel 101 at this point.

Thus, when the adjusting screws 500, 501, 502, and 503 are turned, this generates a force that pushes the right-eye lens barrel 101, and the angle of the right-eye imaging unit 100 can be adjusted around the rotational axis B2 and the rotational axis B3. Even after adjustment, the angle of the right-eye imaging unit 100 around the rotational axis B2 and the rotational axis B3 can be maintained by the adjusting screws 500, 501, 502, and 503.

5. Method for Adjusting Angle of Right-Eye Imaging Unit 100

The method for adjusting the angle of the right-eye imaging unit 100 with the adjustment mechanism 510 will now be described. For example, in adjusting the angle of the right-eye imaging unit 100, first the angle of the right-eye imaging unit 100 with respect to the base plate 300 is adjusted around the rotational axis B3 (the twisting of the right-eye and left-eye images in the rotational direction), after which the angle of the right-eye imaging unit 100 with respect to the is adjusted around the rotational axis B2 (the orientation of the right-eye imaging unit 100 in the up and down direction), and finally the angle of the right-eye imaging unit 100 with respect to the base plate 300 is adjusted around the rotational axis B1 (the orientation of the right-eye imaging unit 100 in the left and right direction). The order in which these adjustments are made is not limited to that given above, and may be some other order.

As shown in FIG. 10, when the angle of the right-eye imaging unit 100 around the optical axis AX1 is adjusted, the adjusting screws 500 and 502 are tightened and the adjusting screws 501 and 503 are loosened, or the other way around, which changes the angle of the right-eye imaging unit 100 with respect to the base plate 300 around the optical axis AX1.

For example, when the adjusting screws 500 and 502 are tightened and the adjusting screws 501 and 503 are loosened, the right-eye imaging unit 100 rotates clockwise with respect to the base plate 300 as seen from the subject side.

On the other hand, when the adjusting screws 500 and 502 are loosened and the adjusting screws 501 and 503 are tightened, the right-eye imaging unit 100 rotates counter-clockwise with respect to the base plate 300 as seen from the subject side.

When the right-eye imaging unit 100 rotates with respect to the base plate 300, the contact face 121 of the contact portion 120 slides with the receiving face 320 of the receiver 310. Since the contact face 121 and the receiving face 320 are formed along the imaginary spherical plane S, the right-eye imaging unit 100 rotates with respect to the base plate 300 around the center C of the imaginary spherical plane S. In this embodiment, since the center C of the imaginary spherical plane S is disposed on the optical axis AX1, turning the adjusting screws 500 to 503 causes the right-eye imaging unit 100 to rotate around the optical axis AX1 (the rotational axis B3) with respect to the base plate 300.

Thus, the angle of the right-eye optical image can be adjusted using the adjusting screws 500, 501, 502, and 503, and the angle of the right-eye optical image around the optical axis AX1 can be set to be substantially equal to the angle of the left-eye optical image around the optical axis AX2. Therefore, this reduces inclination of the subject in the right-eye image with respect to the subject in the left-eye image.

Furthermore, just one of the adjusting screws 500 and 502 may be tightened or loosened, or both may be tightened or loosened. Also, just one of the adjusting screws 501 and 503 may be tightened or loosened, or both may be tightened or loosened.

When the orientation of the right-eye imaging unit 100 in the up and down direction is adjusted, the adjusting screws 500 and 501 are tightened and the adjusting screws 502 and 503 are loosened, or the other way around, which adjusts the orientation of the right-eye imaging unit 100 in the up and down direction with respect to the base plate 300.

For example, when the adjusting screws 500 and 501 are tightened and the adjusting screws 502 and 503 are loosened, this changes the orientation of the right-eye imaging unit 100 downward.

On the other hand, when the adjusting screws 500 and 501 are loosened and the adjusting screws 502 and 503 are tightened, this changes the orientation of the right-eye imaging unit 100 upward. The amount of change in the orientation of the right-eye imaging unit 100 in the up and down direction can be adjusted by adjusting how much the adjusting screws 500, 501, 502, and 503 are turned.

When the right-eye imaging unit 100 rotates with respect to the base plate 300, the contact face 121 of the contact portion 120 slides with the receiving face 320 of the receiver 310. Since the contact face 121 and the receiving face 320 are formed along the imaginary spherical plane S, the right-eye imaging unit 100 rotates with respect to the base plate 300 around the center C of the imaginary spherical plane S. More precisely, the right-eye imaging unit 100 rotates with respect to the base plate 300 around the rotational axis B2, which passes through the center C of the imaginary spherical plane S.

Thus, the adjusting screws 500, 501, 502, and 503 can be used to adjust the orientation of the right-eye imaging unit 100 in the up and down direction, and to reduce offset of the right-eye and left-eye optical images in the up and down direction.

Furthermore, just one of the adjusting screws 500 and 501 may be tightened or loosened, or both may be tightened or loosened. Also, just one of the adjusting screws 502 and 503 may be tightened or loosened, or both may be tightened or loosened.

When the orientation of the right-eye imaging unit 100 is adjusted in the left and right direction, one of the adjusting screws 504 and 505 is tightened and the other loosened, which adjusts the orientation of the right-eye imaging unit 100 in the left and right direction.

For example, when the adjusting screw 504 is tightened and the adjusting screw 505 is loosened, the right-eye imaging unit 100 rotates around the rotational axis B1 to the left-eye imaging unit 200 side (the left side), and the convergence angle increases. When the adjusting screw 504 is loosened and the adjusting screw 505 is tightened, the right-eye imaging unit 100 rotates around the rotational axis B1 to the opposite side from the left-eye imaging unit 200 (the right side), and the convergence angle decreases.

When the right-eye imaging unit 100 rotates with respect to the base plate 300, the contact face 121 of the contact portion 120 slides with the receiving face 320 of the receiver 310. Since the contact face 121 and the receiving face 320 are formed along the imaginary spherical plane S, the right-eye imaging unit 100 rotates with respect to the base plate 300 around the center C of the imaginary spherical plane S. More precisely, the right-eye imaging unit 100 rotates with respect to the base plate 300 around the rotational axis B1, which passes through the center C of the imaginary spherical plane S.

Thus, the adjusting screws 504 and 505 can be used to adjust the orientation of the right-eye imaging unit 100 in the left and right direction, and to adjust the convergence angle.

Just one of the adjusting screws 504 and 505 may be tightened or loosened, or both may be tightened or loosened.

6. Features of Imaging Device 1

(1) As described above, with this imaging device 1, the contact portion 120 and the receiver 310 come into contact at three or more points, and the points of contact between the contact portion 120 and the receiver 310 are disposed on the imaginary spherical plane S, so the right-eye lens barrel 101 can be moved at various angles with respect to the base plate 300. Therefore, the relative angle between the optical axis AX1 of the right-eye optical system 20 and the optical axis AX2 of the left-eye optical system 21 can be adjusted, allowing a good three-dimensional image to be captured.

Also, using the contact portion 120 and the receiver 310 simplifies the adjustment mechanism and affords a more compact device.

As discussed above, with this imaging device 1, good three-dimensional imaging can be performed and the size of the device can be reduced.

(2) As shown in FIG. 8, since the center C of the imaginary spherical plane S is disposed on the optical axis AX1 of the right-eye optical system 20, there will be less offset of the optical axis AX1 of the right-eye optical system 20 in a direction other than the desired direction when the angle of the right-eye lens barrel 101 is adjusted.

For example, when the angle of the right-eye lens barrel 101 around the optical axis AX1 is adjusted, there is almost no change in the orientation of the right-eye lens barrel 101 in the up and down direction or in the left and right direction, and angle adjustment of the right-eye lens barrel 101 is easier.

(3) As shown in FIGS. 8 and 9, the contact face 121 is formed along the imaginary spherical plane S, and the receiving face 320 is also formed along the imaginary spherical plane S. Therefore, with this imaging device 1, the contact area between the contact portion 120 and the receiver 310 can be increased, and the attitude of the right-eye lens barrel 101 with respect to the base plate 300 tends to be more stable.

(4) As shown in FIG. 9, since the elastic plate 400 is sandwiched between the base plate 300 and the nut 410, even if the position of angle of the right-eye lens barrel 101 with respect to the base plate 300 is adjusted, the nut 410 tends to follow the movement of the right-eye lens barrel 101, and the angle adjustment of the right-eye lens barrel 101 can be carried out smoothly in a state in which the right-eye imaging unit 100 is coupled to the base plate 300.

(5) As shown in FIG. 9, the maximum major diameter L3 of the elastic plate 400 is greater than the minimum minor diameter L2 of the opening 330 in the receiver 310, and the major diameter L1 of the washer 411 is less than the minor diameter of the opening 330 in the receiver 310. Therefore, a space in which the elastic plate 400 can elastically deform can be ensured between the washer 411 and the opening 330, and movement of the nut 410 with respect to the base plate 300 is readily absorbed by the elastic plate 400.

(6) Since the left-eye lens barrel 201 is fixed to the base plate 300, if only the angle of the right-eye lens barrel 101 is adjusted, the angle of the right- or left-eye optical image around the optical axis, or the relative offset in the up and down direction, can be adjusted, or the convergence angle can be adjusted. Therefore, the adjustment work is easier than when both the right-eye lens barrel 101 and the left-eye lens barrel 201 are adjusted.

(7) With this imaging device 1, the angle of the right-eye imaging unit 100 in all directions with respect to the base plate 300 can be easily adjusted by using the adjusting screws 500 to 505. Furthermore, the angle can be fine-tuned by adjusting the tightness of the adjusting screws 500 to 505.

### Second Embodiment

In the first embodiment above, the right-eye imaging unit 100 is supposed by the single spherical plane support mechanism 190, but a plurality of spherical plane support mechanisms 190 may be provided. The lens unit 3 pertaining to the second embodiment will now be described.

Those components having substantially the same function as in the above embodiment will be numbered the same and will not be described again in detail.

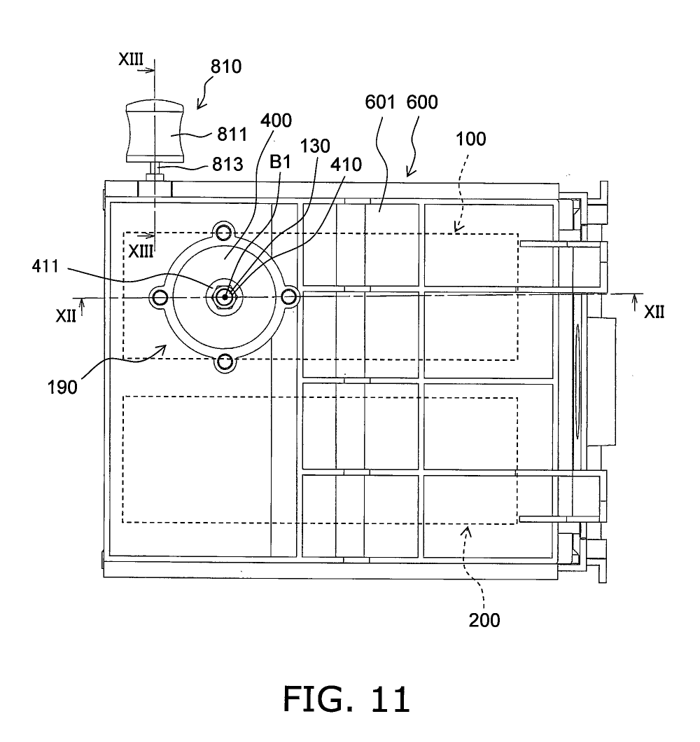

The lens unit 3 pertaining to the second embodiment has the right-eye imaging unit 100 supported by two spherical plane support mechanisms 190. More specifically, as shown in FIG. 11, the lens unit 3 has a main body frame 600 (an example of a frame member). Unlike the above-mentioned base plate 300, the main body frame 600 houses the right-eye imaging unit 100 and the left-eye imaging unit 200. The main body frame 600 has an upper cover member 601 and a lower cover member 602. The upper cover member 601 is fixed to the lower cover member 602.

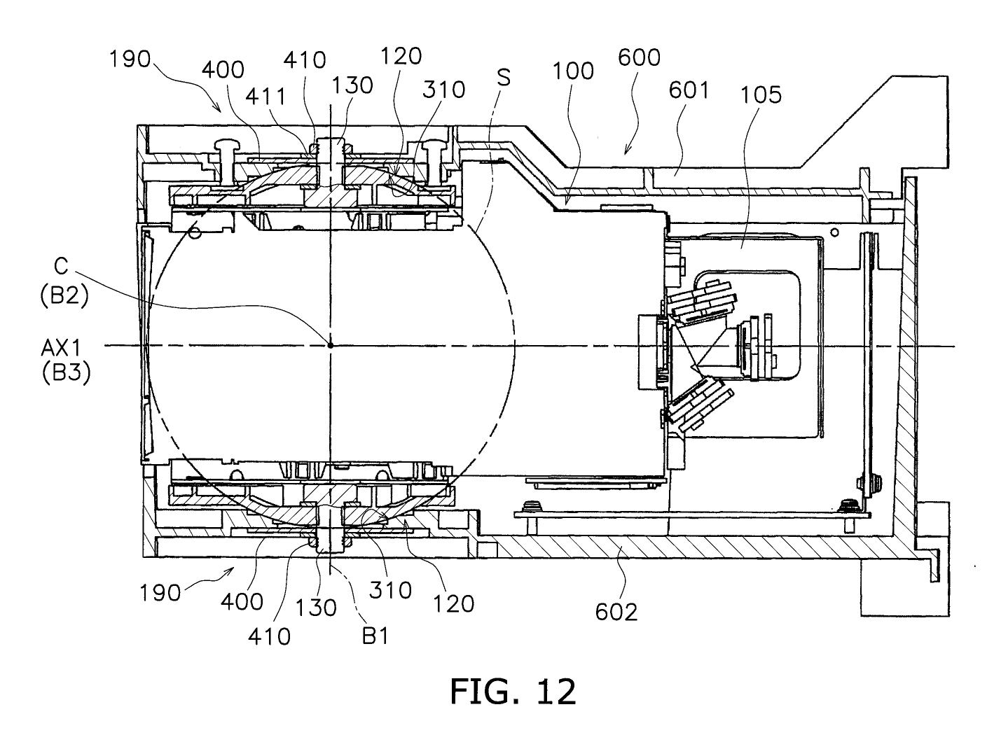

As shown in FIG. 12, the two spherical plane support mechanisms 190 are disposed above and below the right-eye imaging unit 100. The two spherical plane support mechanisms 190 have the same basic configuration. The lower spherical plane support mechanism 190 is similar to the spherical plane support mechanism 190 in the first embodiment in that it is disposed below the right-eye imaging unit 100, and it couples the right-eye imaging unit 100 to the lower cover member 602.

Meanwhile, the upper spherical plane support mechanism 190 is disposed above the right-eye imaging unit 100, and it couples the right-eye imaging unit 100 to the upper cover member 601.

The lens barrel cover 102 of the right-eye imaging unit 100 is similar to the bottom plate 103 in that it has a contact portion 120 (an example of a first or second contact portion). The upper contact portion 120 has a contact face 121 (an example of a contact face) formed along the imaginary spherical plane S. The upper cover member 601 of the main body frame 600 has the receiver 310 (an example of a first or second receiver). The receiver 310 has the receiving face 320 (an example of a receiver) formed along the imaginary spherical plane S. The receiver 310 comes into contact with the contact portion 120 at three or more points. More specifically, the contact portion 120 and the receiver 310 are in planar contact via the contact face 121 and the receiving face 320. The contact points of the contact portion 120 and the receiver 310 are disposed on the imaginary spherical plane S.

The center C of the imaginary spherical plane S is disposed between the two spherical plane support mechanisms 190. More precisely, the center C of the imaginary spherical plane S is disposed between the two contact portions 120.

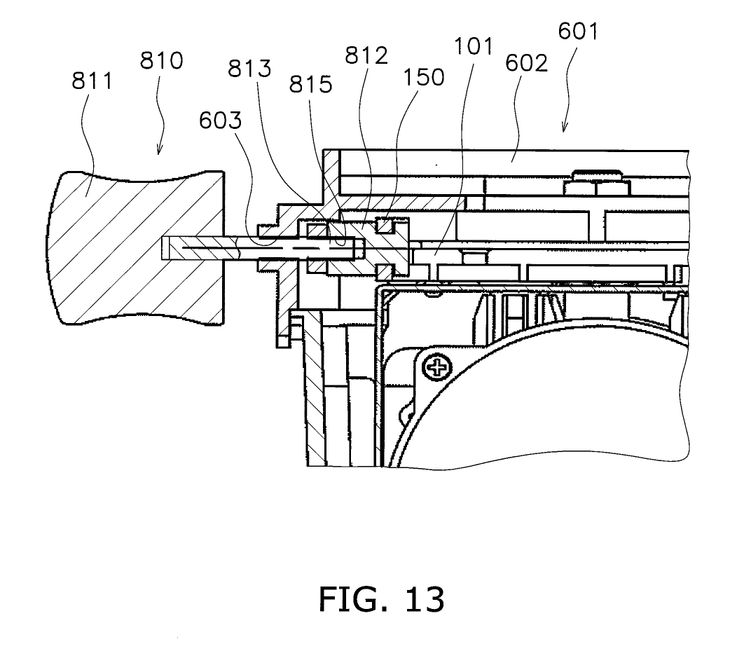

Also, as shown in FIGS. 11 and 13, an adjustment mechanism 810 is provided to the lens unit 3 pertaining to the second embodiment so that it will be easier for the user to adjust the convergence angle. Unlike the adjusting screws 504 and 505 of the adjustment mechanism 510, the adjustment mechanism 810 allows the user to adjust the angle of the right-eye imaging unit 100 around the rotational axis B1 with respect to the main body frame 600 merely by turning one adjustment knob 811.

As shown in FIG. 13, the adjustment mechanism 810 has the adjustment knob 811, a threaded shaft 813, and a coupling member 812. The adjustment knob 811 is operated by the user in adjusting the convergence angle, and is disposed on the side of the main body frame 600. For example, the adjustment knob 811 is disposed on the outside of the housing 10 so that it can be operated by the user.

The threaded shaft 813 is fixed to the adjustment knob 811. Threads are cut into the threaded shaft 813, and the threaded shaft 813 is threaded into a threaded guide hole 603 formed on the side of the main body frame 600. The coupling member 812 is fixed to the distal end of the threaded shaft 813. The coupling member 812 is rotatably mounted to a catch 150 formed on the right-eye lens barrel 101 of the right-eye imaging unit 100. The coupling member 812 moves in the left and right direction (the left and right direction in FIG. 13) with the right-eye lens barrel 101 via the catch 150.

When the adjustment knob 811 is turned, the adjustment knob 811, the threaded shaft 813, and the coupling member 812 rotate integrally. When the threaded shaft 813 rotates with respect to the main body frame 600, the threaded shaft 813 is guided in the left and right direction by the threaded guide hole 603. For example, when the threaded shaft 813 is guided to the right in FIG. 13, the right-eye lens barrel 101 moves to the right side via the coupling member 812. As a result, as shown in FIG. 11, the right-eye imaging unit 100 rotates counter-clockwise around the rotational axis B1.

When the adjustment knob 811 is turned the other way and the threaded shaft 813 is guided to the left side in FIG. 13, the right-eye lens barrel 101 moves to the left side via the coupling member 812. As a result, as shown in FIG. 11, the right-eye imaging unit 100 rotates clockwise around the rotational axis B1.

Thus, it is simple to adjust the convergence angle by operating the adjustment knob 811.

Also, since the right-eye lens barrel 101 is supported by two imaginary spherical planes, the angle adjustment of the right-eye lens barrel 101 is smoother and the support strength of the right-eye lens barrel 101 can be improved. For example, the angle of the right-eye imaging unit 100 can be effectively prevented from becoming offset if the imaging device 1 should be subjected to some kind of impact.

### Other Embodiments

The present invention is not limited to the above embodiments, and various modifications and changes are possible without departing from the scope of the invention.

(1) In the above embodiments, the right-eye imaging unit 100 is supported by the spherical plane support mechanism 190 so that its angle can be adjusted, but the left-eye imaging unit 200 may be supported by the spherical plane support mechanism 190 so that its angle can be adjusted.

Also, in the first embodiment above, the one spherical plane support mechanism 190 is provided below the right-eye imaging unit 100, but the one spherical plane support mechanism 190 may be provided above the right-eye imaging unit 100. For example, in the second embodiment, the lower spherical plane support mechanism 190 may be omitted.

(2) In the above embodiments, the contact portion 120 and the receiver 310 are in planar contact, but the contact portion 120 and the receiver 310 may be in contact at three points disposed on the imaginary spherical plane S. For example, the contact portion 120 need not have the contact face 121, and the receiver 310 need not have the receiving face 320.

Furthermore, the contact face 121 is an annular face, but may be constituted by a plurality of faces formed along the imaginary spherical plane S. Similarly, the receiving face 320 is an annular face, but may be constituted by a plurality of faces formed along the imaginary spherical plane S.

(3) In the above embodiments, the base plate 300 is an integral member, but the base plate 300 may instead be constituted by a plurality of members. For example, a configuration is possible in which a frame member is provided to each of the right-eye imaging unit 100 and the left-eye imaging unit 200, the right-eye imaging unit 100 and the left-eye imaging unit 200 are assembled to their respective frame members, and then the frame members are put together.

(4) In the above embodiments, the center C of the imaginary spherical plane S is disposed on the optical axis AX1, but the center C of the imaginary spherical plane S need not be disposed on the optical axis AX1. For example, the center C of the imaginary spherical plane S may be offset from the optical axis AX1 to the extent that it does not affect the adjustment of angle in the various directions.

(5) The mechanism for adjusting the angle of the right-eye imaging unit 100 is not limited to the above configurations. For example, some of the adjusting screws 500 to 505 may be omitted, or other adjusting screws may be added. Also, the angle adjustment of the right-eye imaging unit 100 may be accomplished by some member other than a screw. In other words, any configuration may be used as long as the angle of the right-eye imaging unit 100 can be adjusted in a state in which the contact portion 120 and the receiver 310 are in contact.

(6) In the first embodiment above, the right-eye imaging unit 100 is supported by the one spherical plane support mechanism 190, but the right-eye imaging unit 100 may be supported by a plurality of spherical plane support mechanisms 190 as in the second embodiment. For example, the right-eye imaging unit 100 may be supported by three or more spherical plane support mechanisms 190.

Also, in the second embodiment the two spherical plane support mechanisms 190 have the same configuration, but as long as the two spherical plane support mechanisms 190 have the same function, the two spherical plane support mechanisms 190 may have different configurations.

(7) In the above embodiments, the right-eye imaging unit 100 is supported in an adjustable state by the spherical plane support mechanism 190, but the left-eye imaging unit 200 may be supported by the spherical plane support mechanism 190 instead of the right-eye imaging unit 100.

Also, in the above embodiments, only the right-eye imaging unit 100 is supported in an adjustable state by the spherical plane support mechanism 190, but both the right-eye imaging unit 100 and the left-eye imaging unit 200 may be supported in an adjustable state by the spherical plane support mechanism 190.

(8) In the above embodiments, the elastic plate 400, the washer 411, and the nut 410 were used as examples to describe support members, but the configuration of the support members is not limited to the above embodiments. For example, the washer 411 need not be sandwiched between the elastic plate 400 and the nut 410.

Also, the elastic plate 400 is disposed between the nut 410 and the base plate 300, but the elastic plate 400 may be omitted as long as the angle of the right-eye imaging unit 100 can be adjusted.

Furthermore, the elastic plate 400 was used as an example in describing an elastic member, but the shape of the elastic member is not limited to that of the elastic plate 400. For example, the elastic member may be a coil spring or a disc spring.

In other words, the support members may have any configuration as long as the right-eye imaging unit 100 can be coupled to the base plate 300 such that the angle of the right-eye imaging unit 100 can be adjusted.

(9) In the above embodiments, the bolt 130 is a separate member from the contact portion 120, but the bolt 130 and the contact portion 120 may be formed integrally.

(10) The configuration of the right-eye optical system 20 and the left-eye optical system 21 is not limited to that in the above embodiments.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment(s), the following directional terms “forward”, “rearward”, “above”, “downward”, “vertical”, “horizontal”, “below” and “transverse” as well as any other similar directional terms refer to those directions of a heat dissipating structure and an imaging device with the heat dissipating structure. Accordingly, these terms, as utilized to describe the present invention should be interpreted relative to a heat dissipating structure and an imaging device with the heat dissipating structure.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. An imaging device, comprising:
a first optical system;
a second optical system;
a first support frame having a first contact portion and configured to support the first optical system;
a second support frame configured to support the second optical system;
a frame member on which the first and second support frames are mounted, the frame member having a first receiver in contact with the first contact portion at three or more points; and
a support member configured to couple the first support frame to the frame member in a state in which the first receiver is in contact with the first contact portion,
the points of contact between the first contact portion and the first receiver being disposed on an imaginary spherical plane.

2. The imaging device according to claim 1, wherein
a center of the imaginary spherical plane is disposed substantially on an optical axis of the first optical system.

3. The imaging device according to claim 1, wherein
the first contact portion in contact with the first receiver has a contact face formed along the imaginary spherical plane.

4. The imaging device according to claim 1, wherein
the first receiver in contact with the first contact portion has a contact face formed along the imaginary spherical plane.

5. The imaging device according to claim 1, wherein
the support member has a fixing member mounted to the first support frame, and an elastic member sandwiched between the frame member and the fixing member, the elastic member configured to be elastically deformable according to changes in an angle of the first support frame with respect to the frame member.

6. The imaging device according to claim 5, wherein
the first receiver has an opening, and
a maximum major diameter of the elastic member is greater than a minimum minor diameter of the opening in the first receiver.

7. The imaging device according to claim 6, wherein
a maximum major diameter of the fixing member is less than the minimum minor diameter of the opening in the first receiver.

8. The imaging device according to claim 6, wherein
the first support frame has a protrusion disposed at the first contact portion,
the protrusion configured to extend into the opening in the first receiver, and
the fixing member is mounted to the protrusion.

9. The imaging device according to claim 8, wherein
the elastic member has a hole, and
the protrusion configured to extend into the hole.

10. The imaging device according to claim 1, wherein
the second support frame is fixed to the frame member.

11. The imaging device according to claim 1, further comprising
an adjustment mechanism configured to adjust an angle of the first support frame with respect to the frame member, wherein
the adjustment mechanism has a first adjustment member provided so that a rotational force can be imparted to the first support frame around a first rotational axis passing through a center of the imaginary spherical plane.

12. The imaging device according to claim 11, wherein
the adjustment mechanism has a second adjustment member provided so that a rotational force can be imparted to the first support frame around a second rotational axis that passes through the imaginary spherical plane and is perpendicular to the first rotational axis.

13. The imaging device according to claim 11, wherein
the adjustment mechanism has a third adjustment member provided so that a rotational force can be imparted to the first support frame around a third rotational axis perpendicular to the first and second rotational axes.

14. The imaging device according to claim 1, wherein
the first support frame further has a second contact portion,
the frame member has a second receiver which is in contact with the second contact portion at three or more points, and
the points of contact between the second contact portion and the second receiver are disposed on the imaginary spherical plane.

15. The imaging device according to claim 14, wherein
a center of the imaginary spherical plane is disposed between the first contact portion and the second contact portion.

16. The imaging device according to claim 14, wherein
the second contact portion in contact with the second receiver has a contact face formed along the imaginary spherical plane.

17. The imaging device according to claim 14, wherein
the second receiver in contact with the second contact portion has a contact face formed along the imaginary spherical plane.

18. The imaging device according to claim 2, wherein
the first contact portion in contact with the first receiver has a contact face formed along the imaginary spherical plane.

19. The imaging device according to claim 2, wherein
the first receiver in contact with the first contact portion has a contact face formed along the imaginary spherical plane.

20. The imaging device according to claim 2, wherein
the support member has a fixing member mounted to the first support frame, and an elastic member sandwiched between the frame member and the fixing member, the elastic member configured to be elastically deformable according to changes in an angle of the first support frame with respect to the frame member.
